(19) United States
(12) Patent Application Publication
(10) Pub. No.: US 2009/0039029 A1
(43) Pub. Date: Feb. 12, 2009

(54) IRON OXIDE RECOVERY

(75) Inventor: VLADIMIR VLAD, Ames, IA (US)

Correspondence Address: MCKEE, VOORHEES & SEASE, P.L.C., 801 GRAND AVENUE, SUITE 3200, DES MOINES, IA, 50309-2721, US

(73) Assignee: EMTECH, LLC, Ames, IA (US)

(21) Appl. No.: 12/188,286

(22) Filed: Aug. 8, 2008

Related U.S. Application Data
(60) Provisional application No. 60/955,188, filed on Aug. 10, 2007.

(51) Int. Cl. C02F 1/48; C02F 1/52; C02F 101/20

(52) U.S. Cl. 210/695; 210/702; 210/222

(57) ABSTRACT

A method for increasing recovery of particulate material from a fluid stream includes directing the fluid stream through a channel, conditioning the fluid stream by applying energy to the fluid stream sufficient to increase concentration of the particulate material, and recovering the particulate material from the fluid stream. The particulate material of interest may be iron oxide in stream of water. The step of applying energy may be performed by applying an electric field or a magnetic field to the fluid stream to facilitate the separation process.

### CROSS-REFERENCE TO RELATED APPLICATIONS

This application claims priority under 35 U.S.C. § 119 to provisional application Ser. No. 60/955,188 filed Aug. 10, 2007, herein incorporated by reference in its entirety.

### BACKGROUND OF THE INVENTION

The present invention relates to iron oxide recovery, and more particularly to the recovery of iron oxide from water sources, such as, but not limited to aquifers. The present invention relates to several problems which may seem unconnected without having the benefit of this disclosure.

One problem relates to arsenic levels in aquifers and other water sources. There is growing concern that materials from landfills, including iron oxide, will form arsenic which will contaminate the aquifers or other water sources. This problem is further complicated by the fact that water from aquifers may include relatively high levels of iron oxide. The water is used in a process, such as in ethanol processing, and the iron oxide eventually becomes a part of waste material which is then disposed of at a landfill. Thus, using the water from aquifers in certain processes, may result in further contaminating the aquifers. Therefore, there exists significant environmental issues related to the iron oxide present in water.

Another problem relates to the need for iron oxide material. Iron oxide is used in a number of applications, including, but not limited to use in color pigments, construction coatings, ceramic, rubber, plastics, papermaking, leather, and magnetic materials, and electronic components such as resistors and semiconductors.

### BRIEF SUMMARY OF THE INVENTION

Therefore, it is a primary object, feature, or advantage of the present invention to improve over the state of the art.

It is a further object, feature, or advantage of the present invention to recover iron oxide from aquifer water.

It is a further object, feature, or advantage of the present invention to assist in reducing iron oxide in waste materials disposed in landfills.

It is a still further object, feature, or advantage of the present invention to provide a flow through system for removing particulate mater such as iron oxide.

One or more of these and/or other objects, features, or advantages of the present invention will become apparent from the specification and claims that follow.

According to one aspect of the present invention, a method for increasing recovery of particulate material of interest from a fluid stream is provided. The method includes directing the fluid stream through a channel, conditioning the fluid stream by applying energy to the fluid stream sufficient to increase concentration of the particulate material of interest, and recovering the particulate material of interest from the fluid stream.

According to another aspect of the present invention, a method for recovering iron oxide from a water stream is provided. The method includes directing the water stream through a channel, at a first stage, applying a magnetic field to the water stream at the channel sufficient to increase recoverable concentration of the iron oxide, and at a second stage, recovering the iron oxide from the fluid stream using a magnetic separator.

According to another aspect of the present invention, a method for recovering iron oxide from aquifer water is provided. The method includes directing the aquifer water through a channel, applying energy to aquifer water flowing through the channel to facilitate later separation of the iron oxide via using the magnetic separator by increasing recoverable concentration of the iron oxide in the aquifer water, and separating the iron oxide from the aquifer water using the magnetic separator.

According to another aspect of the present invention, a method for recovering iron oxide from a fluid includes altering a magnetic property of the iron oxide within the fluid to facilitate later separation of the iron oxide from the fluid, and recovering the iron oxide from the fluid using a magnetic separator.

According to another aspect of the present invention, a system for separating particulate matter from fluid includes a fluid channel carrying a mixture comprising particulate matter and fluid, a conditioner positioned along the fluid channel to apply energy to the mixture flowing through the channel to alter magnetic properties associated with the mixture and to thereby facilitate separation of the particulate matter from the fluid, and a magnetic separator positioned along the fluid channel after the energy altering apparatus and adapted to separate the particulate matter from the fluid after alternation of the magnetic properties associated with the mixture.

### BRIEF DESCRIPTION OF THE DRAWINGS

FIG. 1 is an SEM image of particles present in aquifer water.

FIG. 2 is a block diagram illustrating one embodiment of a system of the present invention.

FIG. 3 illustrates one embodiment of a methodology of the present invention.

FIG. 4 illustrates one embodiment of a device that may be used to modify magnetic properties associated with the iron oxide.

FIG. 5 illustrates another embodiment of a device that may be used to modify magnetic properties associated with the iron oxide.

FIG. 6 is a photograph illustrating two different conditioning devices that may be inserted into the fluid channel to modify magnetic properties of the iron oxide.

FIG. 7 is a diagram illustrating one embodiment of the present invention where electricity is applied proximate a magnetic separator.

### DETAILED DESCRIPTION OF THE PREFERRED EMBODIMENT

The present invention relates to improving the ability to separate particulate such as iron oxide from a fluid such as water. The present invention provides for conditioning the fluid mixture prior to separation to increase the effectiveness of the separation.

As an initial test, two aquifer water samples were taken. A permanent magnet was placed in one of the samples. The sample without the magnet remained clear. The sample with the magnet developed a reddish-brown tint indicative of an iron oxide presence.

For further testing, aquifer water was obtained and tested to determine the mass of particles present in a given volume size of solution, the particle sizes (typical), and the particle morphology via SEM images. In addition, aquifer water exposed to a magnetic field created by insertion of a permanent magnet was also tested. The results of the testing revealed the following:

### Baseline Sample:

Total mass of solution=14.9171 grams
Mass of particles after drying=0.1148 grams
Wt % solid particles=0.7696%

### Magnetic Sample:

Total mass of solution=15.9838 grams
Mass of particles after drying=0.1412 grams
Wt % of solid particles=0.8833%

### Difference in Wt %:

14.8% more solid particles in Magnetic sample

The above measurements show that the magnetic solution mass was only 7.15% more than the baseline sample, but it contained 23% more mass of solid particles (3×more).

Particle size measurement revealed an average particle size of 570um+/− 170 um for 8 representative particles measured for the baseline sample. Particle size measurement revealed an average particles size of 540 um+/− 190 um for the 14 representative particles measured in the magnetic sample.

Testing of the magnetic sample revealed the following estimated or qualitative chemical analysis on the magnetic sample of aquifer water:

| Compound | Cmpd Wt % |
|---|---|
| MgO | 4.42 |
| SiO2 | 14.94 |
| CaO | 55.80 |
| Fe₂O₃ | 24.84 |

Subsequent testing was performed on aquifer water samples to determine (1) mass of particles present in a given volume of solution; (2) particle sizes (typical) of the aquifer solution via SEM images; and (3) particle morphology via SEM images.

In order to determine the mass of particles present in a given volume the solutions needed to be dried so that only the solid particles remained. This was accomplished using a two-step drying cycle.

First, a known volume of solution for each sample was placed into a ceramic boat and weighed followed by insertion into an oven set at T=200° C. This exposure evaporates all of the free H₂O molecules. After drying, the samples were re-weighed and mass balance calculations performed to determine the mass of the dried particles and the wt % of solid particles in each solution.

The second step of the drying cycle consisted of exposing the already dried particles from the 200° C. step to a temperature of 600° C. for 1 hour. The reasoning behind this higher temperature drying is that oxy-hydrates of iron are known to exist, such as Fe₂O₃.xH₂O, which contain a significant volume of bonded water that will not be released or evaporated at 200° C. Typically temperatures>400° C. must be achieved in order to release the bonded water molecules. Removal of this “attached” water will result in higher purity iron oxide particles. Both drying steps occurred in an air atmosphere

### Water 1 Sample After 200° C. Drying Step:

Volume of solution=25.5 ml
Total mass of solution=24.963 grams
Mass of particles after drying=0.015 grams
Wt % solid particles=0.06%

### Water 1 Sample After 600° C. Drying Step:

Mass of particles after drying=0.011 grams
Wt % solid particles=0.04%

### Water 2 Sample After 200° C. Drying Step:

Volume of solution=20 ml
Total mass of solution=18.5695 grams
   Mass of particles after drying=0.0218 grams
   Wt % of solid particles=0.12%
   Water 2 sample after 600° C. drying step:

Mass of particles after drying=0.011 grams

Wt % of solid particles=0.06%
Difference in Wt %=50% more solid particles in Water 2 sample

The above measurements show that the Water 2 sample contained 50% more solid particles for similar solution volumes. It should be noted that the Water 1 sample was clear in color while the Water 2 sample had a reddish-brown tint indicative of an iron oxide presence.

On a Particle per Volume Basis:
Water 1=0.43 g/L=1.63 g/gallon
Water 2=0.55 g/L=2.08 g/gallon (28% higher particle per volume)

Upon completion of drying and weighing the particles were collected for SEM analysis to determine particle size and shape. Particles of each dried solution were placed on double-sided copper tape and inserted into the SEM after which images were obtained and particle measurements taken.

### Water 1

No images were obtained due to a lack of solid particles present after the drying process. The particles collected were not easy to see with the naked eye. They were white/clear in color unlike the Water 2 sample particles which had a strong red-brown color.

### Water 2

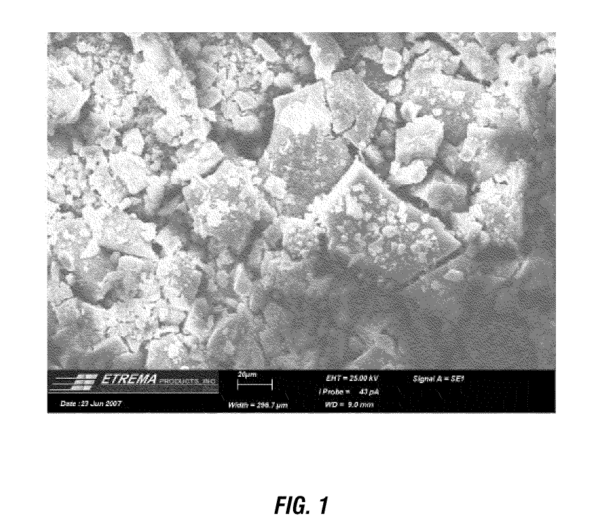

Images were captured from the SEM for the Water 2 sample. FIG. 1 illustrates an example of the images. SEM analysis indicated the presence of a wide distribution of particle sizes. The larger particles had an average measured grain size of 55 μm (max size measured=69 μm) while the smaller particles had sizes of<10 μm, with many appearing to be sub-micron in size.

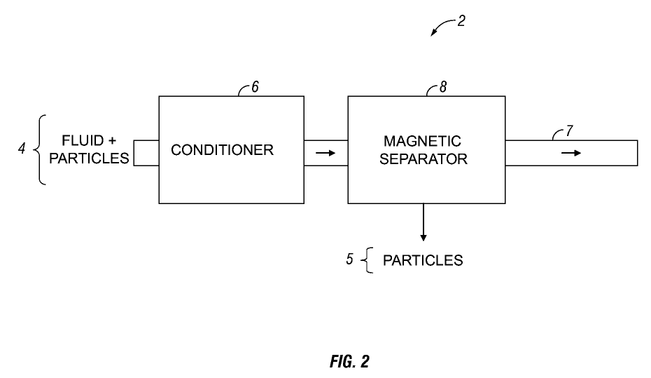

The present invention provides for using the effect on the magnetic properties of iron oxide within aquifer water to assist in separating and recovering the iron oxide. FIG. 2 illustrates one embodiment of a system of the present invention. In FIG. 2, the system 2 includes a fluid channel 7. A fluid mixture 4 of fluid and particles flow through the fluid channel 7 to a conditioner 6. The conditioner provides for altering energy associated with the fluid mixture 4 in order to facilitate separation. The conditioner may apply an electrical or magnetic field to alter magnetic properties of the particles thereby resulting an increasing the recoverable concentration of the particles. Next, a magnetic separator 8 is provided which separates and recovers the particles 5. Thus, the present invention provides for using the effect on the magnetic properties of particles such as iron oxide within a fluid mixture such as aquifer water to separate and recover the iron oxide.

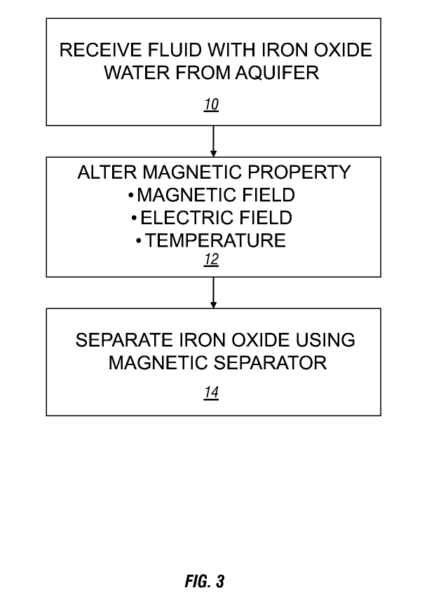

An overview of one embodiment of a method of the present invention is described in FIG. 3 in the context of iron oxide separated from water in an aquifer. In step 10, a fluid with iron oxide is received. The source of the fluid with iron oxide may be an aquifer, although other sources, are contemplated. Next, in step 12, magnetic properties associated with the iron oxide are modified, such as through applying a magnetic field, applying an electric field, or altering temperature. Then, in step 14, iron oxide is separated from the fluid using a magnetic trap or magnetic separator. Thus, in this manner, iron oxide is separated from the fluid. As previously explained, applying a magnetic fields increases the recoverable concentration of iron oxide. In this manner applying the magnetic field, electric field, or alteration in temperature facilitates the recovery of iron oxide. Note that although a magnetic field may be applied, the magnetic field is not used in the manner associated with a magnetic separator. Here, the magnetic field alters magnetic properties associated with the iron oxide or fluid stream to condition the fluid mixture and facilitate the later recovery of the iron oxide.

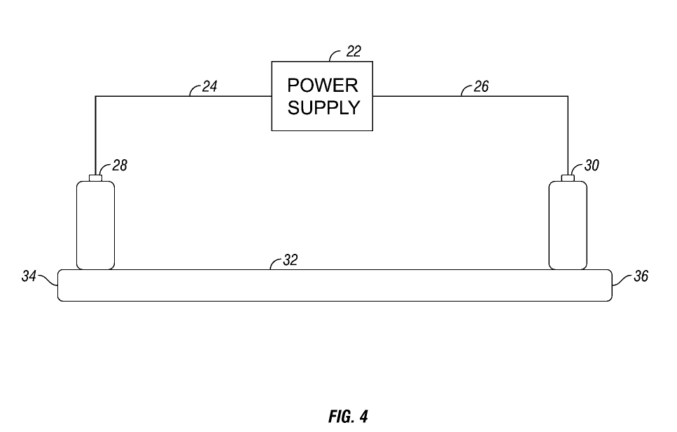

FIG. 4 illustrates one embodiment of a conditioner device that may be used to modify magnetic properties associated with the iron oxide. The conditioner 20 applies an electric field to the fluid mixture passing through the tube 32. The fluid mixture contains iron oxide particles. A power supply 22 with line 24 connected to a graphite electrode 28 and line 26 connected to graphite electrode 30. The opposite graphite electrodes 28, 30 are placed a distance apart along a fluid channel 32 and electricity is applied to generate an electric field. Of course, the present invention contemplates numerous variations in the manner that an electric field is applied to the fluid flowing through the pipe.

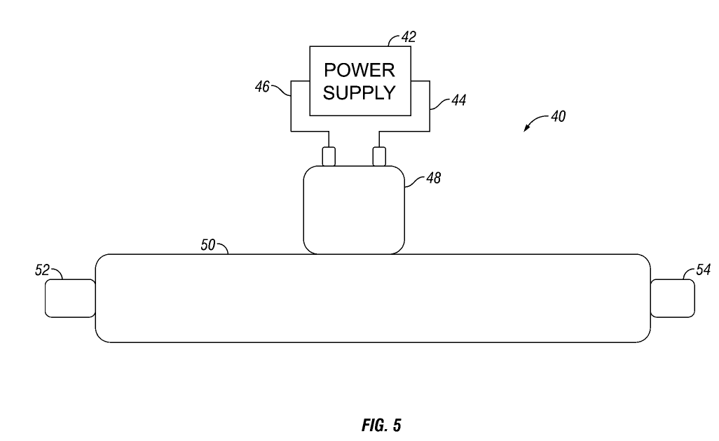

FIG. 5 illustrates another embodiment of a conditioner device 40 that may be used to modify magnetic properties associated with the iron oxide. The conditioner device 40 has a power supply 42 with lines 44, 46, connected to an electromagnet 48. The conditioner device 40 includes a fluid channel 50 with an inlet 52 and an outlet 54. The electromagnet 48 is formed from a plurality of coil turns which are energized. The fluid flows through the coil while the coil is electrified to thereby apply a magnetic field to the fluid mixture.

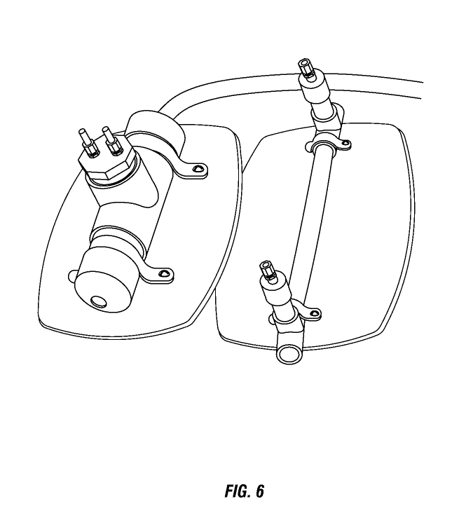

FIG. 6 is a photograph illustrating two of the devices that may be inserted into the fluid channel to modify magnetic properties of the iron oxide. To the left is a device which applies a magnetic field to fluid and iron oxide passing through by energizing an electromagnet inside the device which is formed from a plurality of coil turns. The fluid flows through the coil while the coil is electrified to thereby apply a magnetic field to the fluid. To the right is a device which applies an electric field to the fluid and iron oxide passing through. Opposite graphite electrodes are placed a distance apart along a fluid channel and electricity is applied to generate an electric field.

Instead of applying a magnetic field or an electric field, heat may be applied to the fluid instead such a through use of one or more heating coils. However, the electric field or magnetic field is generally preferred in a commercial environment where large amounts of fluid are involved due to the costs of producing the heat and the desire to maintain continuous flow.

As previously discussed after conditioned by the conditioner, magnetic separation may be performed to separate the iron oxide from the fluid. The present invention contemplates that any number of types of magnetic separators may be used for separating the iron oxide from the fluid, including, without limitation, magnetic traps, drum-type magnetic separators, and other type of magnetic separators. One example of drum-type magnetic separator is the Electro Wet Drum Magnetic Separator, Model 8, available from Eriez' Laboratory. In some applications it would be preferred that the magnetic separator allow for continuous flow of the fluid. Because the conditioner induces a proper change in the magnetic properties associated with the iron oxide, the conditioner makes the iron oxide susceptible to separation by the magnetic separator.

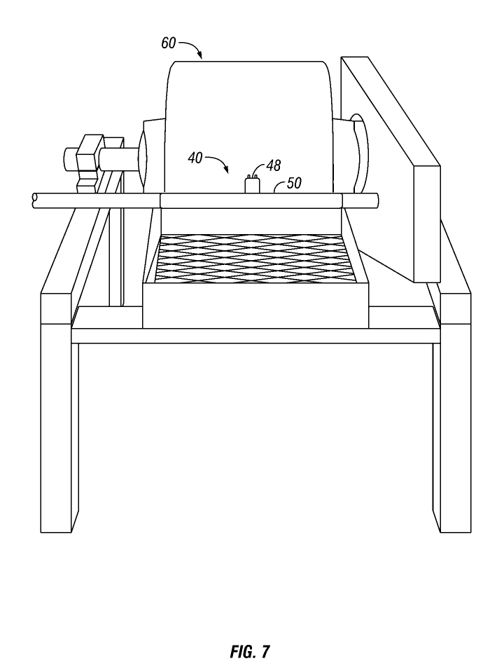

FIG. 7 is a diagram illustrating one embodiment of the present invention where electricity is applied proximate a magnetic separator. In FIG. 7, a wet drum magnetic separator 60 is shown. An electric field is applied to the fluid mixture (which includes water and iron oxide particles) in the manner shown in FIG. 5 using the conditioner 40. The conditioner 40 applies an electric field to the fluid mixture passing through the tube 50. The fluid mixture contains iron oxide particles. The application of the electric field prior to the magnetic separation provides for altering magnetic properties of the iron oxide and/or the fluid to assist in the recovery process. Although not wishing to be bound by the theory of operation, it is believed that the electric field (or alternatively heat or magnetic field) increases the paramagnetic properties of the iron oxide, which then enhances the effectiveness of the magnetic separation. The electric field may be applied at or near the magnetic separator as shown.

It should be appreciated that the present invention provides a number of benefits and advantages. The iron oxide can be easily separated from water from an aquifer. After separation, the water can be used in any number of applications, including ethanol processing. Because the iron oxide is removed from the water prior to its use, the iron oxide does not become a part of the waste products that may end up in a landfill where the iron oxide would potentially lead to increased arsenic levels.

In addition to this advantage, there is value in the iron oxide which has been recovered, particularly where the iron oxide is recovered in small particle sizes. The iron oxide can be used in any number of applications, including, but not limited to in color pigments, construction coatings, ceramic, rubber, plastics, papermaking, leather, and magnetic materials, and electronic components such as resistors and semiconductors.

Therefore a method of recovering iron oxide has been disclosed. The present invention contemplates numerous variations, including whether the fluid with iron oxide is water from an aquifer or another source of water, whether an electrical field, magnetic field, or temperature change is used to make the fluid/iron oxide more susceptible to separation using a magnetic separator, and other variations within the spirit and scope of the invention. The present invention is not to be limited to the specific embodiments provided herein.

What is claimed is:

1. A method for increasing recovery of particulate material of interest from a fluid stream, comprising:
directing the fluid stream through a channel;
conditioning the fluid stream by applying energy to the fluid stream sufficient to increase concentration of the particulate material of interest; and
recovering the particulate material of interest from the fluid stream.

2. The method of claim 1 wherein the channel is a tube.

3. The method of claim 2 wherein the fluid stream comprises water.

4. The method of claim 3 wherein the particulate matter of interest comprises a ferrous material.

5. The method of claim 4 wherein the ferrous material comprises iron oxide.

6. The method of claim 5 wherein the recovering the particulate material being performed using a magnetic separator.

7. The method of claim 6 wherein the particulate matter having particles of a size of less than 100 micrometers.

8. The method of claim 7 wherein the applying energy to the fluid stream at the channel comprises applying a magnetic field to the fluid stream.

9. The method of claim 8 wherein the magnetic field being electrically induced.

10. The method of claim 9 wherein the fluid stream comprise water.

11. The method of claim 10 wherein the water being water obtained from an aquifer.

12. A method for recovering iron oxide from a water stream, comprising:
directing the water stream through a channel;
at a first stage, applying a magnetic field to the water stream at the channel sufficient to increase recoverable concentration of the iron oxide; and
at a second stage, recovering the iron oxide from the fluid stream using a magnetic separator.

13. A method for recovering iron oxide from aquifer water, comprising:
directing the aquifer water through a channel;
applying energy to aquifer water flowing through the channel to facilitate later separation of the iron oxide via using the magnetic separator by increasing recoverable concentration of the iron oxide in the aquifer water; and
separating the iron oxide from the aquifer water using the magnetic separator.

14. The method of claim 13 wherein the step of applying energy is applying a magnetic field.

15. The method of claim 13 wherein the step of applying energy is applying an electric field.

16. The method of claim 13 wherein the energy is heat energy.

17. A method for recovering iron oxide from a fluid, comprising:
altering a magnetic property of the iron oxide within the fluid to facilitate later separation of the iron oxide from the fluid;
recovering the iron oxide from the fluid using a magnetic separator.

18. The method of claim 17 wherein the step of altering the magnetic property of the iron oxide is performed by applying a magnetic field within the fluid.

19. The method of claim 18 wherein the magnetic field being electrically induced.

20. The method of claim 18 wherein the step of altering the magnetic property of the iron oxide is performed by applying an electric field.

21. The method of claim 18 wherein the step of altering the magnetic property of the iron oxide is performed by altering heat energy.

22. A system for separating particulate matter from fluid, the system comprising:
a fluid channel carrying a mixture comprising particulate matter and fluid;
a conditioner positioned along the fluid channel to apply energy to the mixture flowing through the channel to alter magnetic properties associated with the mixture and to thereby facilitate separation of the particulate matter from the fluid;
a magnetic separator positioned along the fluid channel after the energy altering apparatus and adapted to separate the particulate matter from the fluid after alternation of the magnetic properties associated with the mixture.

23. The system of claim 22 wherein the conditioner applies a magnetic field to the fluid channel.

24. The system of claim 23 wherein the magnetic field being electrically induced.

25. The system of claim 22 wherein the particulate matter comprises iron oxide.
